(19) United States
(12) Patent Application Publication
(10) Pub. No.: US 2026/0277640 A1
(43) Pub. Date: Sep. 17, 2026

(54) AUTOMATICALLY CREATING NEW, AND UPDATING OUTDATED, DEMO VIDEOS USING RELATIONSHIP TREES

(71) Applicant: INTERNATIONAL BUSINESS MACHINES CORPORATION, ARMONK, NY (US)

(72) Inventors: Xiang Jun Liu, Shanghai (CN); Jing Lei Guo, Ningbo (CN); Dong Yu Cai, Shanghai (CN); Yu Li, Beijing (CN); Zhan Peng Huo, Beijing (CN); Peng Hui Jiang, Beijing (CN); Yi Chen Zhang, Shanghai (CN); Meng Chai, Shanghai (CN)

(21) Appl. No.: 19/079,807

(22) Filed: Mar. 14, 2025

(51) Int. Cl. G06F 9/451; G06F 8/70; G06T 11/00

(52) U.S. Cl. CPC G06F 9/453; G06F 8/70; G06T 11/00

(57) ABSTRACT

A computer-implemented method for automatically generating new, and updating existing, videos associated with a technology. The method may further include automatically extracting video source information from a video. The method may also include automatically identifying in the video, technical features and components corresponding to the technology. The method may further include automatically extracting source code information from the technology. The method may also include automatically identifying current technical features and components corresponding to the technology. The method may further include automatically mapping the technical features and components identified based on the video source information to the current technical features and components. The method may also include, based on the mapping, automatically detecting one or more differences between the technical features and components. The method may further include, automatically generating and incorporating new video frames in the video corresponding to the current technical features and components identified in the technology.

### BACKGROUND

The present invention relates generally to the field of computing, and more specifically, to automatically generating as well as updating demonstration videos using machine learning to more effectively demonstrate current technical features and components of a given technology.

Generally, a demonstration (demo) video may illustrate and/or instruct individuals on how a certain technology works by, for example, showing the technology in action. Demo videos can also provide a compelling way to communicate certain technical features as well as value of a given technology. By visually demonstrating how a technology works and highlighting important technical features, user can understand how the technology can meet the user's needs. Furthermore, the internet has become an increasingly visual space, and as such, videos have become increasingly important for such things as accurately portraying a technology's functionality, consistently updating videos where necessary, and even search engine optimization.

### SUMMARY

A computer-implemented method for automatically generating new, and updating existing, videos associated with a technology is provided. The computer-implemented method may include receiving a video associated with the technology. The computer-implemented method may further include, based on receiving the video, automatically extracting video source information from the video that corresponds to the technology. The computer-implemented method may also include, based on the extracted video source information, automatically identifying, in each video frame associated with the video, technical features and components corresponding to the technology. The computer-implemented may further include automatically extracting source code information from the technology. The computer-implemented method may also include, based on the extracted source code information, automatically identifying, in the technology, current technical features and components corresponding to the technology. The computer-implemented method may further include automatically mapping the technical features and components identified based on the video source information and from each video frame to the current technical features and components identified based on the source code information. The computer-implemented method may also include, based on the mapping, automatically detecting one or more differences between the technical features and components identified in each video frame to the current technical features and components identified in the technology. The computer-implemented method may further include, based on detecting the one or more differences, automatically generating and incorporating at least one new video frame in the video that corresponds to the current technical features and components identified in the technology.

A computer system for automatically generating new, and updating existing, videos associated with a technology is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a computer-implemented method. The computer-implemented method may include receiving a video associated with the technology. The computer-implemented may further include, based on receiving the video, automatically extracting video source information from the video that corresponds to the technology. The computer-implemented method may also include, based on the extracted video source information, automatically identifying, in each video frame associated with the video, technical features and components corresponding to the technology. The computer-implemented method may further include automatically extracting source code information from the technology. The computer-implemented method may also include, based on the extracted source code information, automatically identifying, in the technology, current technical features and components corresponding to the technology. The computer-implemented method may further include automatically mapping the technical features and components identified based on the video source information and from each video frame to the current technical features and components identified based on the source code information. The computer-implemented method may also include, based on the mapping, automatically detecting one or more differences between the technical features and components identified in each video frame to the current technical features and components identified in the technology. The computer-implemented method may further include, based on detecting the one or more differences, automatically generating and incorporating at least one new video frame in the video that corresponds to the current technical features and components identified in the technology.

A computer program product for automatically generating new, and updating existing, videos associated with a technology is provided. The computer program product may include one or more computer-readable storage devices and program instructions stored on at least one of the one or more tangible storage devices, the program instructions executable by a processor. The computer program product may include program instructions to retrieve a database schema by extracting metadata associated with at least one database. The computer program product may include program instructions to receive a video associated with the technology. The computer program product may also include program instructions to, based on receiving the video, automatically extract video source information from the video that corresponds to the technology. The computer program product may further include program instructions to, based on the extracted video source information, automatically identify, in each video frame associated with the video, technical features and components corresponding to the technology. The computer program product may also include program instructions to automatically extract source code information from the technology. The computer program product may further include program instructions to, based on the extracted source code information, automatically identify, in the technology, current technical features and components corresponding to the technology. The computer program product may also include program instructions to automatically map the technical features and components identified based on the video source information and from each video frame to the current technical features and components identified based on the source code information. The computer program product may further include program instructions to, based on the mapping, automatically detecting one or more differences between the technical features and components identified in each video frame to the current technical features and components identified in the technology. The computer program product may include program instructions to, based on detecting the one or more differences, automatically generate and incorporate at least one new video frame in the video that corresponds to the current technical features and components identified in the technology.

### BRIEF DESCRIPTION OF THE SEVERAL VIEWS OF THE DRAWINGS

These and other objects, technical features and advantages of the present invention will become apparent from the following detailed description of illustrative embodiments thereof, which is to be read in connection with the accompanying drawings. The various technical features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is a block diagram of an operational flowchart for a program for automatically generating new, and updating existing, videos associated with a technology according to one embodiment;

FIG. 3 is an example diagram of a demo video that includes a video frame of a technology, whereby the technology is a software application/program that includes a user interface according to one embodiment;

FIG. 4 is an example diagram of a mapping/comparison between user interface (UI) and user experience (UX) relationship trees according to one embodiment;

FIG. 5 is an example diagram of generating a new demo video by replacing existing video frames with new video frames that reflect changes to existing technical features and components of a technology according to one embodiment;

FIG. 6 is an example diagram of generating a new demo video by specifically adding/inserting new video frames reflecting new technical features and components of a technology in the video according to one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known technical features and techniques may be omitted to avoid unnecessarily obscuring the presented embodiments.

Embodiments of the present invention relate generally to the field of computing, and more particularly, to automatically generating new, and updating existing, videos associated with a technology. Specifically, the present invention may improve the technical field associated with demonstration videos, and more specifically, with the generation and production of demo videos based on a process which may automatically detect whether a demonstration/depiction of a technology in a demo video is outdated according to the technical features and components in the video as mapped and compared to current/latest information associated with the technology.

As previously described, a demonstration (demo) video may illustrate and/or instruct individuals on how a certain technology works by, for example, showcasing the technology in action. While existing artificial intelligence (AI) video generators may be used to generate a video, such existing AI video generators primarily include text-to-video generation using simple text prompts or relying on storyboards generated from received data. While such video generation may be suitable for simple promotional or educational videos, this approach falls short when creating demo videos that needs to effectively showcase how a technology operates as well as engage user interaction especially when dealing with changing technical features of rapidly changing technologies. Accordingly, the complexity of demo videos necessitates a high level of accuracy to accurately portray a technology's functionality at a current state. More specifically, with the release of new technical features (such as new pages and user interface designs), there is a constant need to keep demo videos up to date.

As such, it may be advantageous to, among other things, provide a method, computer system, and computer program product that may automatically generate new and/or update existing, but outdated, demonstration videos. Specifically, the method, computer system, and computer program product may include receiving a video associated with the technology. The method, computer system, and computer program product may further include, based on receiving the video, automatically extracting video source information from the video that corresponds to the technology. The method, computer system, and computer program product may also include, based on the extracted video source information, automatically identifying, in each video frame associated with the video, technical features and components corresponding to the technology. The method, computer system, and computer program product may further include automatically extracting source code information from the technology. The method, computer system, and computer program product may also include, based on the extracted source code information, automatically identifying, in the technology, current technical features and components corresponding to the technology. The method, computer system, and computer program product may further include automatically mapping the technical features and components identified based on the video source information and from each video frame to the current technical features and components identified based on the source code information. The method, computer system, and computer program product may also include, based on the mapping, automatically detecting one or more differences between the technical features and components identified in each video frame to the current technical features and components identified in the technology. The method, computer system, and computer program product may further include, based on detecting the one or more differences, automatically generating and incorporating at least one new video frame in the video that corresponds to the current technical features and components identified in the technology.

More specifically, receiving a video associated with the technology may have the technical effect of determining whether the video associated with the technology is outdated.

Furthermore, automatically extracting video source information from the video that corresponds to the technology may have the technical effect of identifying information that is in the video.

Also, automatically identifying, in each video frame associated with the video, technical features and components corresponding to the technology may also have the technical effect of identifying information specifically associated with the technology in the video.

Furthermore, automatically extracting source code information from the technology may have the technical effect of determining current information associated with the technology itself.

Even further, automatically identifying, in the technology, current technical features and components corresponding to the technology may similarly have the technical effect of identifying the technical features and components currently associated with the technology.

As such, automatically mapping the technical features and components identified based on the video source information and from each video frame to the current technical features and components identified based on the source code information may have the technical effect of detecting outdated features and components associated with the technology in the video to therefore indicate that the video is outdated.

In turn, automatically detecting one or more differences between the technical features and components identified in each video frame to the current technical features and components identified in the technology may have the technical effect of determining whether specific features and components are outdated in the video.

Accordingly, automatically generating and incorporating at least one new video frame in the video that corresponds to the current technical features and components identified in the technology may have the technical effect of updating any outdated video associated with the technology.

The present invention may be a computer system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer program product and computer readable storage medium, as those terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to automatically generate new, and updating existing, videos associated with a technology.

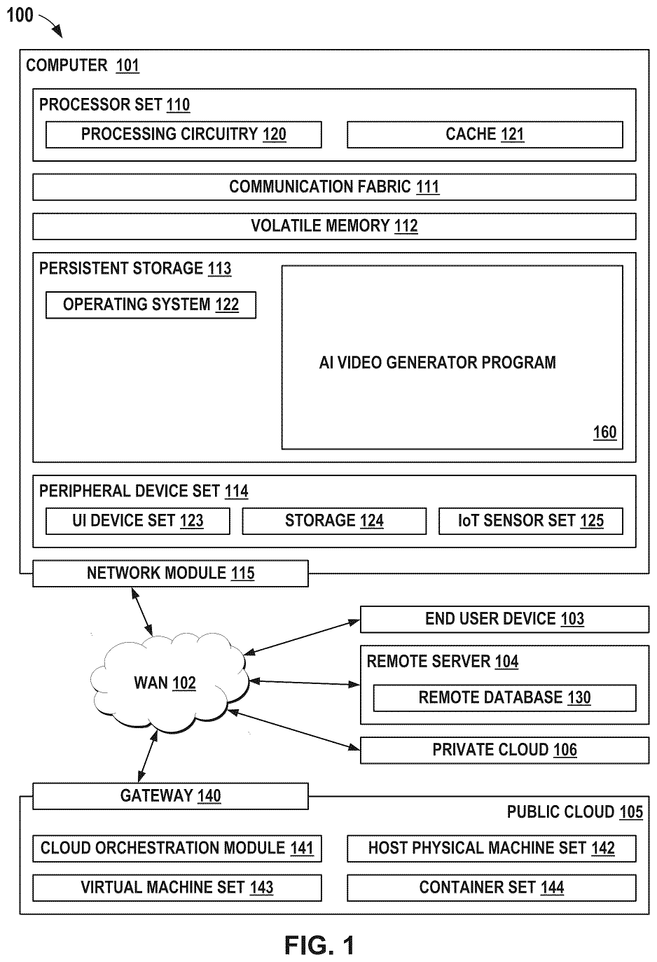

Referring to FIG. 1, an exemplary computing environment 100 is depicted, according to at least one embodiment. Computing environment 100 contains an example of an environment for the execution of at least some of the computer code involved in performing the inventive methods, such as an artificial intelligence (AI) video generator program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network and/or querying a database, such as database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system technical feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a technical feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

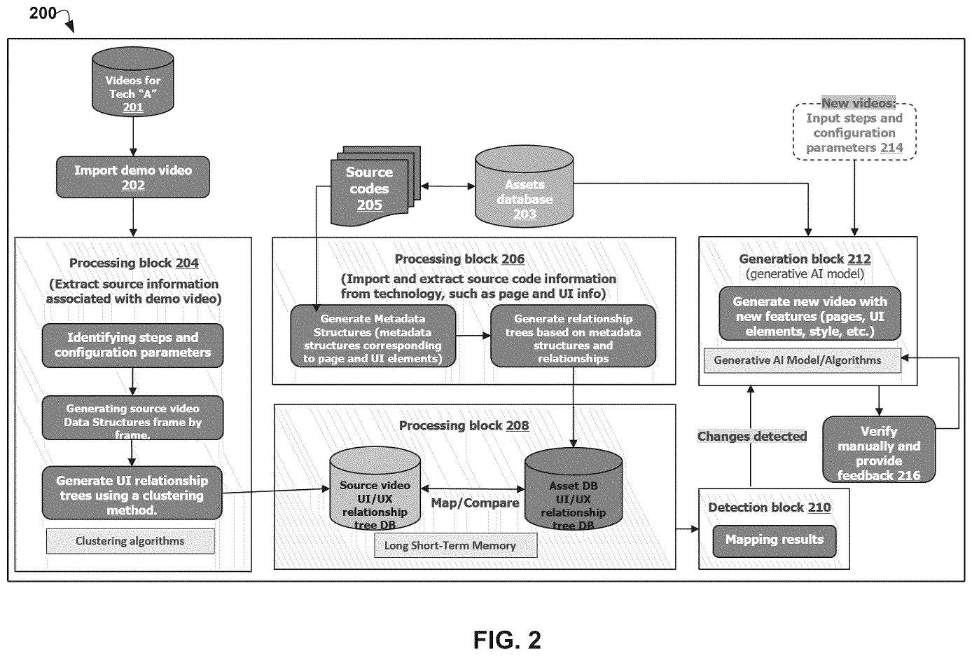

Furthermore, notwithstanding depiction in computer 101, the AI video generator program 160 may be stored in and/or executed by, individually or in any combination, with end user device 103, remote server 104, public cloud 105, and private cloud 106. The AI video generator program is explained in further detail below with respect to FIGS. 2-6.

According to the present embodiment, and as previously described, the AI video generator program 160 may be a program/code capable of automatically generating new and/or update existing, but outdated, demonstration videos. The AI video generator program 160 may receive a video associated with the technology. The AI video generator program 160 may, based on receiving the video, automatically extract video source information from the video that corresponds to the technology. The AI video generator program 160 may, based on the extracted video source information, automatically identify, in each video frame associated with the video, technical features and components corresponding to the technology. The AI video generator program 160 may automatically extract source code information from the technology. The AI video generator program 160 may, based on the extracted source code information, automatically identify, in the technology, current technical features and components corresponding to the technology. The AI video generator program 160 may automatically map the technical features and components identified based on the video source information and from each video frame to the current technical features and components identified based on the source code information. The AI video generator program 160 may, based on the mapping, automatically detect one or more differences between the technical features and components identified in each video frame to the current technical features and components identified in the technology. The AI video generator program 160 may, based on detecting the one or more differences, automatically generate and incorporate at least one new video frame in the video that corresponds to the current technical features and components identified in the technology.

Referring now to FIG. 2, a block diagram illustrating an operational flowchart 200 of a program for automatically generating new and/or updating existing, but outdated, videos associated with a technology is provided. Specifically, according to one embodiment and as depicted in FIG. 2 at 202, the AI video generator program 160 may import/receive a video which may include a demonstration (demo) video associated with a technology ‘A’. For example, the technology ‘A’ may include, but is not limited to, a computer software application and/or program (such as on-premise software and software as a service (SaaS)), as well as other products, services, and devices. In a case where the technology ‘A’ includes a software application and/or program, the technology may include technical features and components such as different computer software pages, user interfaces, and other software components (such as user interface (UI) elements) corresponding to the software application/program, as well as interactions between the different software pages, the user interfaces, and the software components which may represent a user experience (UX).

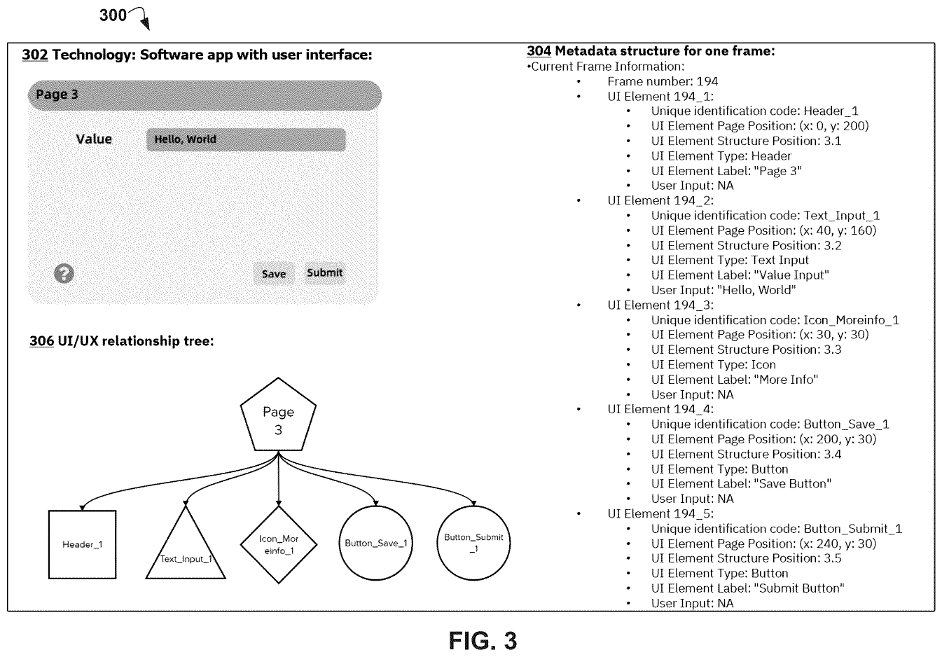

As previously described, a demo video may include a video that may display the technical features and components and illustrate and/or instruct users of the technology and on how the technology works based on a demonstration of the technical features and components in a video sequence via one or more video frames. An example diagram of a demo video that includes a video frame of the technology ‘A’, whereby the technology ‘A’ is a software application/program that further includes a user interface, is depicted at 302 in diagram 300 of FIG. 3. Also, according to one embodiment, the AI video generator program 160 may also include a database for storing different demo videos associated with the different software applications/programs, products, services, and devices, such as a database 201. Furthermore, according to one embodiment, the AI generator program 160 may include web crawling/scraping algorithms to identify demo videos, for example, on the internet/web such as on a website and/or web application, and store the demo videos on database 201. As such, importing/receiving the demonstration video may include automatically retrieving/importing demo videos from the database 201 which may include stored demo videos uploaded to the database 201 as well as demo videos identified on the internet/web using the web crawling/scraping algorithms.

The AI generator program 160 may further include an asset database 203 as depicted in FIG. 2, whereby the asset database 203 may be used for storing current/latest technical features and components associated with a technology such as technology ‘A’. For example, in the case of technology ‘A’ being a software application/program (such as an on-premise program, website, or SaaS), the AI generator program 160 may store source code information corresponding to the technology and including current technical features and components such as current software page information, user interface (UI) elements and corresponding identification codes representing the UI elements included in each page/product interface. According to one embodiment, the asset database 203 may also store current/latest manuals and other documents associated with the current/latest information and the latest technical features and components. According to one embodiment, based on detecting changes to the asset database (such as adding, removing, and/or replacing UI elements, technical features, manuals, and/or other documentation), and more specifically, changes to information corresponding to a specific technology/product (such as technology ‘A’), the AI video generator program 160 may automatically retrieve/import a demo video associated with that specific technology (as depicted at step 202) by searching for and identifying any existing demo video that may correspond to the specific technology to, in turn, determine whether the existing demo video is outdated based on any changed information and according to the following steps.

Thereafter, and as depicted at 204, based on receiving the video, the AI video generator program 160 may automatically extract video source information from the video, generate metadata files that include metadata structures extracted from and associated with each video frame in the video and, in turn, generate a relationship tree based on each metadata structure to represent the technical features and components as well as interactions between the technical features and components as depicted in the video. Specifically, and as depicted at 204, the AI video generator program 160 may extract video source information associated with the video, whereby the video source information may include video data and metadata information corresponding to different steps and configuration parameters associated with different video frames in the video as well as corresponding to the technical features and components of the technology. Based on the extracted video source information, the AI generator program 160 may generate a metadata file including a metadata structure for each video frame associated with the video. An example metadata structure for a video frame is depicted at 304 in FIG. 3 which provides a metadata structure for a video frame 302 that is associated with a previously described software application/program that includes a user interface (UI) and corresponding user experience (UX) based on interactions between UI elements. In turn, and as further depicted in 204, the AI video generator program 160 may use the metadata files/structures associated with the video frame 302 to generate UI/UX relationship trees which may represent the technical features and components including information such as the architecture of different pages, different statuses of a same UI element as well as different UI elements on different pages, and interactions between the different UI elements on different pages based on the different video frames. An example UI/UX relationship tree is depicted at 306 in FIG. 3, which is based on an imported/received demo video that includes the UI 302, as well as based on the metadata structure 304 for the video frame 302 that includes the UI.

According to one embodiment, the AI video generator program 160 may include one or more of the following algorithms and techniques to identify and extract video source information including metadata information from each video frame as well as identify relationships between different video frames and UI elements to generate the UI/UX relationship tree: a.) video frame technical feature extraction algorithms that utilize convolutional neural networks (CNNs) and/or pre-trained image classification algorithms such as ResNet or Inception to extract visual technical features from video frames to capture visual information such as the UI elements of a given technology; b.) similarity calculation algorithms that calculate a similarity between technical features including measuring a similarity between the different video frames, whereby the similarity calculation algorithms may include cosine similarity, Euclidean distance, and/or deep learning-based similarity metrics like siamese networks or triplet loss; c.) sequence matching algorithms for identifying sequences in consecutive video frames, whereby recurrent neural networks (RNNs) or Transformers may be used to capture contextual information between video frame sequences and perform matching or the similarity calculation; d.) video frame clustering algorithms which may include clustering algorithms such as k-means and/or hierarchical clustering to group video frames into clusters and further identify the UI elements, assign similar frames to a same category, and identify video frames containing a same technical feature (such as a UI element) and/or same product page.

Thus, as described above at 204, the AI video generator program 160 may extract video source information that is specifically associated with the video corresponding to the technology, generate a metadata file that includes metadata information/structure extracted from and associated with each video frame in the demo video, and use the metadata files/structures associated with the video frames to generate UI/UX relationship trees. Similarly, at 206, the AI video generator program 160 may import/receive and extract source code information from the technology itself. Specifically, for example, the AI video generator program 160 may extract source code information which may further include metadata information and current technical features and components information such as UI and page information from the technology ‘A’ which, as previously described, may be a software application and/or program that includes different software pages and user interfaces. More specifically, and as previously described, the AI generator program 160 may include an asset database 203 as depicted in FIG. 2, whereby the asset database 203 may be used for storing current/latest technical features and components associated with a technology including, for example, storing current page information as well as current user interface (UI) elements and corresponding identification codes representing the current UI elements included in each product/page interface. The asset database 203 may also store the current/latest manuals and other documents associated with the latest information and the current/latest technical features and components. As such, the AI video generator program 160 may extract the source code information 205 from the stored information on the asset database 203. In turn, and as depicted at 206, the AI video generator program 160 may generate metadata structures corresponding to each page, UI element, and relationship between the UI elements which were similarly described with respect to the metadata structures generated for each video frame associated with the video at 204 (and described at 302, 304, and 306 in FIG. 3). In turn, and as further depicted in 206, the AI video generator program 160 may use the metadata files/structures based on the source code information to generate UI/UX relationship trees which may represent the current technical features and components and similarly include information such as the architecture of different pages, different statuses of a same UI element as well as different UI elements on different pages, and interactions between the different UI elements on different pages.

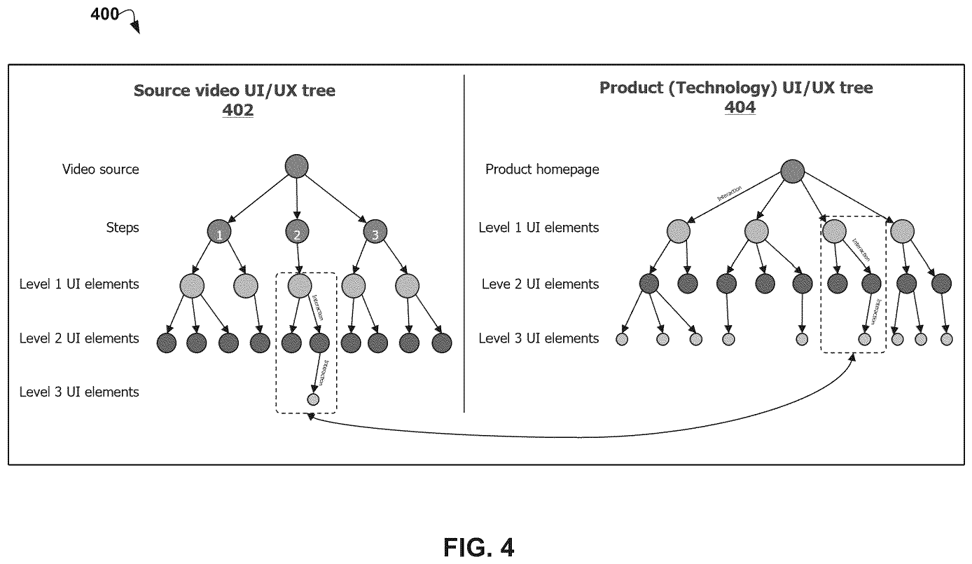

In turn, at 208, the AI video generator program 160 may map and compare the UI/UX relationship tree(s) based on the video and the video source information with the UI/UX relationship tree(s) based on the technology itself and the source code information from the technology which may include the current/latest information stored on the asset database 203. Specifically, and as depicted at 210, based on mapping/comparison results, the AI video generator program 160 may detect whether the UI/UX relationship tree(s) based on the video may be outdated (further indicating that the video is outdated), such as by determining differences between page information and/or UI elements according to the mapping of the UI/UX relationship tree of the demo video to the UI/UX relationship tree of the current/latest information stored on the asset database 203. According to one embodiment, the AI video generator program 160 may include and use machine learning algorithms, such as long short-term memory (LSTM) algorithms, to map and compare the different UI/UX relationship trees. An example diagram of the mapping/comparison of UI/UX relationship trees 400 is depicted in FIG. 4. As depicted in FIG. 4, the generated UI/UX relationship tree 402 associated with source video may be mapped to the generated UI/UX relationship tree 404 that is based on the stored current information (source code information) on the asset database 203 and associated with the technology. As depicted in FIG. 4, the generated UI/UX relationship tree associated with the source video 402 (and video source information) may include the video corresponding to the technology, operational steps depicting a demo of the technology in the video, level 1 UI elements, level 2 UI elements, and level 3 UI elements as well as interactions between different UI elements. Similarly, the generated UI/UX relationship tree 404 that is based on the stored current information (source code information) on the asset database 203 may include the technology's homepage (in the case where the technology is a software app/program), level 1 UI elements, level 2 UI elements, and level 3 UI elements as well as interactions between the different UI elements.

Thereafter, and as previously described at 210, based on the mapping/comparison, the AI video generator program 160 may detect whether the UI/UX relationship tree(s) associated with the video may be outdated, such as by determining whether page information and/or UI elements have been changed according to the mapping of the UI/UX relationship tree based on the video to the UI/UX relationship tree based on the current/latest information associated with the technology that is stored on the asset database 203. As such, in response to detecting that the UI/UX relationship tree(s) associated with the video is outdated based on the mapping/comparison described above and based on the stored current/latest information on the asset database 203, the AI video generator program 160 may, at 212, generate a new video. According to one embodiment, the AI video generator program 160 may detect that the UI/UX relationship tree(s) associated with the demo video is outdated, and therefore, that the demo video is outdated, by determining changes based on the mapping/comparison whereby such changes may include the adding, removal, and/or rearranging of pages, UI elements, and other technical features/components, further including style changes to the pages and UI elements.

As such, and as depicted at 212, the AI video generator program 160 may further include generative artificial intelligence (AI) algorithms to generate a new video (or new demo video) by, for example, replacing video frames in the imported/received demo video with new video frames reflecting any detected changes, or generating and adding new video frames that reflects new pages and/or other new technical features/components based on the source code information. The generative AI algorithms may further include AI video generator algorithms that can create videos from information derived from text, images, and/or video. Accordingly, and as depicted at 214, the AI video generator program 160 may generate a new demo video by using the generative AI algorithms to identify information within the received/imported video and input and/or replace steps and configuration parameters of the received/imported demo video.

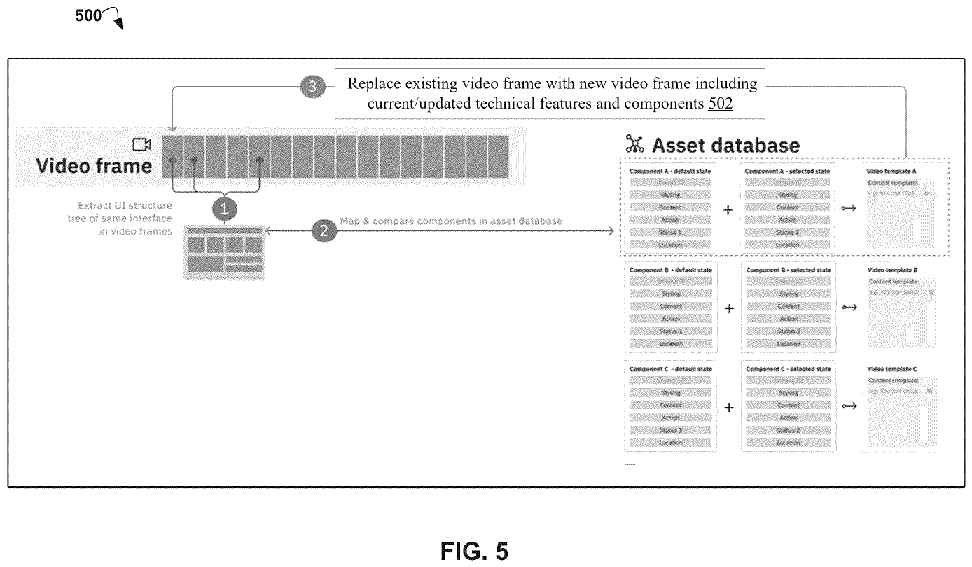

An example diagram of generating a new demo video 500 by, for example, replacing existing video frames with new video frames that reflect changes to existing technical features and components (such as existing pages and UI elements) of a technology is depicted in FIG. 5. More specifically, and as depicted at 502 (step 3) in FIG. 5, the AI video generator program 160 may use the generative AI algorithms to identify, on the asset database 203, new/updated technical features and components (such as new/updated pages and UI elements) to generate video frames corresponding to the new/updated technical features and components that may replace the existing video frames. In turn, and as depicted at 502 in FIG. 5, the AI video generator program 160 may replace an existing video frame in the demo video with a new video frame reflecting the new/updated technical features and components.

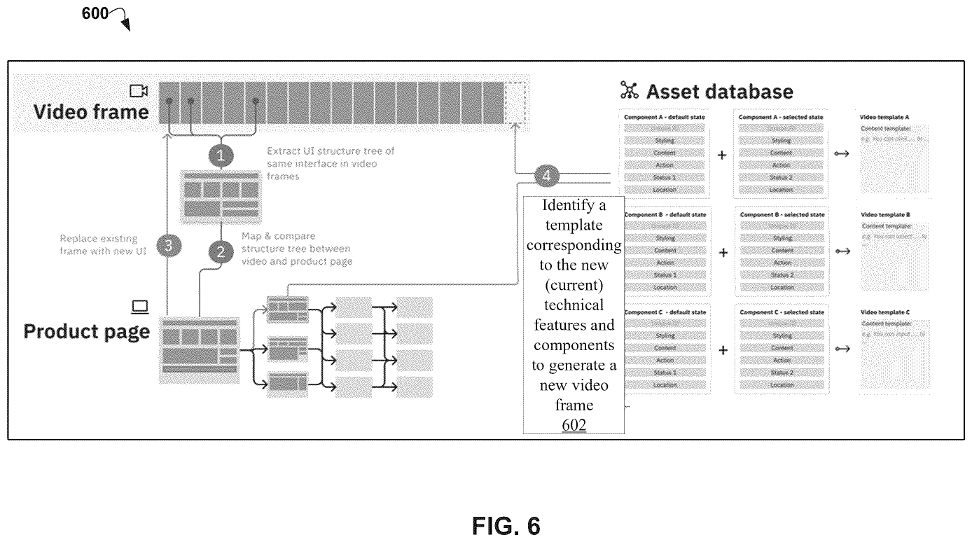

Another example of generating a new demo video 600 by, for example, specifically adding/inserting new video frames reflecting new technical features and components (such as adding a video frame containing a new page) of a technology in the video is depicted in FIG. 6. More specifically, and as depicted at 602 (step 4) in FIG. 6, the AI video generator program 160 may use the generative AI algorithms to identify, on the asset database 203, a template corresponding to the new technical features and components (such as a new page and corresponding new steps and/or new configuration parameters) to generate a new video frame corresponding to the new (current) technical features and components. In turn, and as depicted at 604 in FIG. 6, the AI video generator program 160 may add the new video frame reflecting the new technical features and components, whereby the new video frame may be inserted at different points in the video as an addition to video frames already in the video. The AI video generator program 160 may further include a feedback block 216, which may include a prompt and/or user interface for receiving feedback (such as receiving natural language text) and/or other manual input (such as verification of the generated new video via the UI), to receive feedback related to the generated new video.

It may be appreciated that FIGS. 2-6 provide only illustrations of one implementation and does not imply any limitations with regard to how different embodiments may be implemented. Many modifications to the depicted environments may be made based on design and implementation requirements.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, and as previously described, machine learning as described herein may broadly refer to machine learning algorithms that may learn from data and provide output. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

What is claimed is:

1. A computer-implemented method for automatically generating new, and updating existing, videos associated with a technology, the computer-implemented method comprising:
receiving a video associated with the technology;
based on receiving the video, automatically extracting video source information from the video;
based on the extracted video source information, automatically identifying, in each video frame associated with the video, technical features and components corresponding to the technology;
automatically extracting source code information from the technology;
based on the extracted source code information, automatically identifying, in the technology, current technical features and components corresponding to the technology;
automatically mapping the technical features and components identified based on the video source information and from each video frame to the current technical features and components identified based on the source code information;
based on the mapping, automatically detecting one or more differences between the technical features and components identified in each video frame to the current technical features and components identified in the technology; and
based on detecting the one or more differences, automatically generating and incorporating at least one new video frame in the video that corresponds to the current technical features and components identified in the technology.

2. The computer-implemented method of claim 1:
wherein the technology comprises a computer application or program; and
wherein the technical features and components and the current technical features and components comprise different computer software pages, user interfaces, and software components corresponding to the computer application or program, and further comprises interactions between the different computer software pages, the user interfaces, and the software components to represent a user experience.

3. The computer-implemented method of claim 1, wherein the video comprises a demonstration video displaying the technical features and components of the technology in a video sequence via one or more video frames.

4. The computer-implemented method of claim 3, further comprising:
based on the extracted video source information associated with the video, generating a metadata file including a metadata structure representing the technical features and components from a video frame from the one or more video frames associated with the video; and
generating a first relationship tree representing the technical features and components and interactions between the technical features and components.

5. The computer-implemented method of claim 4, further comprising:
based on the extracted source code information associated with the technology, generating a different metadata file including a different metadata structure for representing the current technical features and components associated with the technology; and
generating a second relationship tree representing the current technical features and components and interactions between the current technical features and components.

6. The computer-implemented method of claim 5, wherein automatically mapping the technical features and components based on the video source information and from each video frame to the current technical features and components based on the source code information further comprises:
mapping the generated first relationship tree representing the technical features and components based on the video source information to the generated second relationship tree representing the current technical features and components based on the source code information.

7. The computer-implemented method of claim 3, wherein automatically generating and incorporating the at least one new video frame in the video further comprises at least one of:
replacing the one or more video frames in the video with the at least one new video frame to reflect changes to the technical features and components in the video; and
inserting the at least one new video frame in the video to reflect new technical features and components corresponding to the current technical features and components identified in the technology, whereby the generated at least one new video frame may be inserted at a point in the video as an addition to the one or more video frames already present in the video.

8. A computer system for automatically generating new, and updating existing, videos associated with a technology, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing operational steps comprising:
receiving a video associated with the technology;
based on receiving the video, automatically extracting video source information from the video;
based on the extracted video source information, automatically identifying, in each video frame associated with the video, technical features and components corresponding to the technology;
automatically extracting source code information from the technology;
based on the extracted source code information, automatically identifying, in the technology, current technical features and components corresponding to the technology;
automatically mapping the technical features and components identified based on the video source information and from each video frame to the current technical features and components identified based on the source code information;
based on the mapping, automatically detecting one or more differences between the technical features and components identified in each video frame to the current technical features and components identified in the technology; and
based on detecting the one or more differences, automatically generating and incorporating at least one new video frame in the video that corresponds to the current technical features and components identified in the technology.

9. The computer system of claim 8:
wherein the technology comprises a computer application or program; and
wherein the technical features and components and the current technical features and components comprise different computer software pages, user interfaces, and software components corresponding to the computer application or program, and further comprises interactions between the different computer software pages, the user interfaces, and the software components to represent a user experience.

10. The computer system of claim 9, wherein the video comprises a demonstration video displaying the technical features and components of the technology in a video sequence via one or more video frames.

11. The computer system of claim 10, further comprising:
based on the extracted video source information associated with the video, generating a metadata file including a metadata structure representing the technical features and components from a video frame from the one or more video frames associated with the video; and
generating a first relationship tree representing the technical features and components and interactions between the technical features and components.

12. The computer system of claim 11, further comprising:
based on the extracted source code information associated with the technology, generating a different metadata file including a different metadata structure for representing the current technical features and components associated with the technology; and
generating a second relationship tree representing the current technical features and components and interactions between the current technical features and components.

13. The computer system of claim 12, wherein automatically mapping the technical features and components based on the video source information and from each video frame to the current technical features and components based on the source code information further comprises:
mapping the generated first relationship tree representing the technical features and components based on the video source information to the generated second relationship tree representing the current technical features and components based on the source code information.

14. The computer system of claim 10, wherein automatically generating and incorporating the at least one new video frame in the video further comprises at least one of:
replacing the one or more video frames in the video with the at least one new video frame to reflect changes to the technical features and components in the video; and
inserting the at least one new video frame in the video to reflect new technical features and components corresponding to the current technical features and components identified in the technology, whereby the generated at least one new video frame may be inserted at a point in the video as an addition to the one or more video frames already present in the video.

15. A computer program product for automatically generating new, and updating existing, videos associated with a technology, comprising:
one or more tangible computer-readable storage devices and program instructions stored on at least one of the one or more tangible computer-readable storage devices, the program instructions executable by a processor, the program instructions comprising:
receiving a video associated with the technology;
based on receiving the video, automatically extracting video source information from the video;
based on the extracted video source information, automatically identifying, in each video frame associated with the video, technical features and components corresponding to the technology;
automatically extracting source code information from the technology;
based on the extracted source code information, automatically identifying, in the technology, current technical features and components corresponding to the technology;
automatically mapping the technical features and components identified based on the video source information and from each video frame to the current technical features and components identified based on the source code information;
based on the mapping, automatically detecting one or more differences between the technical features and components identified in each video frame to the current technical features and components identified in the technology; and
based on detecting the one or more differences, automatically generating and incorporating at least one new video frame in the video that corresponds to the current technical features and components identified in the technology.

16. The computer program product of claim 15, wherein the video comprises a demonstration video displaying the technical features and components of the technology in a video sequence via one or more video frames.

17. The computer program product of claim 16, further comprising:
based on the extracted video source information associated with the video, generating a metadata file including a metadata structure representing the technical features and components from a video frame from the one or more video frames associated with the video; and
generating a first relationship tree representing the technical features and components and interactions between the technical features and components.

18. The computer program product of claim 17, further comprising:
based on the extracted source code information associated with the technology, generating a different metadata file including a different metadata structure for representing the current technical features and components associated with the technology; and
generating a second relationship tree representing the current technical features and components and interactions between the current technical features and components.

19. The computer program product of claim 18, wherein automatically mapping the technical features and components based on the video source information and from each video frame to the current technical features and components based on the source code information further comprises:
mapping the generated first relationship tree representing the technical features and components based on the video source information to the generated second relationship tree representing the current technical features and components based on the source code information.

20. The computer program product of claim 16, wherein automatically generating and incorporating the at least one new video frame in the video further comprises at least one of:
replacing the one or more video frames in the video with the at least one new video frame to reflect changes to the technical features and components in the video; and
inserting the at least one new video frame in the video to reflect new technical features and components corresponding to the current technical features and components identified in the technology, whereby the generated at least one new video frame may be inserted at a point in the video as an addition to the one or more video frames already present in the video.
